(19) United States
(12) Patent Application Publication
(10) Pub. No.: US 2018/0308075 A1
(43) Pub. Date: Oct. 25, 2018

(54) METHOD, SYSTEM, SERVER AND CLIENT FOR CLIENT CONFIGURATION

(71) Applicant: GUANGZHOU UCWEB COMPUTER TECHNOLOGY CO., LTD., Guangzhou City (CN)

(72) Inventors: Jie LIANG, Guangzhou (CN); Qiuyun LIAO, Guangzhou (CN); Yiqiang GUO, Guangzhou (CN); Liang WU, Guangzhou (CN)

(21) Appl. No.: 15/769,413

(22) PCT Filed: Oct. 27, 2016
(86) PCT No.: PCT/CN2016/103545

§ 371 Date: Apr. 19, 2018

(30) Foreign Application Priority Data
Nov. 2, 2015 (CN) 201510741941.5

(51) Int. Cl. G06Q 20/10; H04L 12/24; H04L 29/08; G06Q 20/32

(52) U.S. Cl. CPC G06Q 20/105; H04L 41/0806; G06Q 20/322; H04L 67/34; H04L 67/18

(57) ABSTRACT

The present invention discloses a client configuration method, a system, a server, and a client. The method provided in embodiments of the present invention includes receiving a configuration information request for client initialization and acquiring country information of the client from the request for initializing the configuration information; acquiring configuration information corresponding to the country information from a configuration information database of a server, the configuration information database storing information of countries and corresponding configuration information in a correlative manner; and sending the acquired configuration information to the client to complete initialization of the configuration information of the client. As such, the client country can be configured in a client-side transparent manner prior to processing the actual online business, thereby improving the configuration efficiency and the system compatibility, and optimizing the user experience.

This application claims the priority of Chinese Patent Application No. CN201510741941.5, filed on Nov. 2, 2015, the content of which is incorporated herein by reference in its entirety.

### FIELD OF THE INVENTION

The present invention generally relates to the field of client interaction and, more particularly, relates to methods, systems, servers and clients for client configuration.

### BACKGROUND

In the context of globalization, the globalization of online business also becomes more common. However, as different countries have different economic levels, customs, business practices and consumption patterns, it is very important to provide different and advanced online business configuration schemes that are suitable for different countries.

With personal computers, smart phones, and tablets becoming popular, more and more people nowadays use small-sized but handy clients (e.g. mobile clients) to interact with the Internet. For a specific client, it is inefficient and also a waste of resources if the configuration information for every country is provided to the client.

Therefore, there is a need to provide a client configuration method, system, server, and client that are capable of configuring online business according to the client's country.

### BRIEF SUMMARY OF THE INVENTION

The present invention provides a client configuration method, system, server, and client capable of configuring online business according to the client's country such that the efficiency for providing configuration information and the utilization of resources may be improved.

According to one aspect of the present invention, a method for providing configuration information to a client is provided. The method includes: receiving a configuration information request for client initialization and acquiring the country information of the client from the configuration information request; and acquiring the configuration information corresponding to the country information from a configuration information database of a server, the configuration information database storing the information of countries and the corresponding configuration information in a correlative manner; and sending the acquired configuration information to the client to complete the initialization of the client configuration information.

In this way, by using the server to store storing the configuration information of all relevant countries, and providing the configuration information corresponding to the client's country during the initialization stage of the client, the client is able to complete specific configuration according to the country where the client is located at each startup and, thus, useless configuration of the client and unnecessary occupation of the storage space may be avoided. Timely updating of the country-related information may be ensured (while unnecessary updates for irrelevant countries may be avoided). As such, the configuration and the usage efficiency of the client may be improved.

Preferably, the country information and the corresponding configuration information stored in the configuration information database are updated when the server is connected to a new country or when the correlative configuration information changes.

Because the country information in the configuration information database can always be updated at a very first time, the client is always able to directly obtain the latest country configuration information each time when it starts up (that is, the configuration of specific country information is completed on the server side). Therefore, the client compatibility and usage efficiency may be improved.

Preferably, the configuration information may be payment environment configuration information.

In an online business, payment is a very important link and cashing method. In the present invention, a unified checkout counter for international payment can provide different payment options according to different countries and different consumption levels without extra burden for client processing, storage, and updating. As such, the user payment experience may be improved, and the profit growth of the service provider may be promoted.

Preferably, the configuration information may include at least one of the following: a merchandise pricing method and corresponding price information; and selectable payment methods, or selectable payment methods and the applicable conditions.

In this way, by providing the currency and the payment method corresponding to the country instead of universally using, for example, U.S. dollar credit cards for payment, it is convenient for the user to make a payment, and avoid unnecessary expenses (for example, credit card transaction fees, currency conversion fees, etc.). As such the user experience may be further enhanced.

Preferably, the selectable payment methods may include at least one of the following: client mobile operator payment, credit card payment, saving card payment, and payment through a payment platform of the corresponding country.

In this way, all kinds of users are able to conveniently make payments at the same time such that the universality and the pertinence of the payment methods are ensured.

Preferably, the above method for providing configuration information to the client further includes: acquiring the operator information of the client from the configuration information request. As a result, operator payment can be realized, which facilitates the majority of smartphone users.

Preferably, in the configuration information database, a prioritized payment method is set for at least one country. The configuration information may further include a prioritized payment method; an instruction for displaying the prioritized payment method; and an instruction for directly jumping to the prioritized payment method when the applicable conditions of the prioritized payment method are satisfied.

As such, in countries where a highly popular and convenient payment method (such as Alipay in China, and using an operator for payment in India within a given limit) exists, a direct jump/payment option list is provided to further optimize the user's payment experience, and thus promote the profit growth of the service providers.

According to another aspect of the present invention, a client configuration method is provided. The client configuration method includes: performing initialization of a client, and identifying the country information of the client based on the device information; sending a configuration information request to a server, the configuration information request including the country information; receiving the configuration information returned from the server that corresponds to the country information; and completing the initialization of the client configuration information by configuring the client according to the configuration information.

In this way, because the client obtains the configuration information of the client's country during the initialization stage, and also configures the client according to the configuration information of the country before the actual service, unnecessary transfer, storage, processing, and updating are avoided, and thus the usage efficiency of the client is improved.

Preferably, the configuration information may be payment environment configuration information, and in the step of configuring the client according to the configuration information, the payment environment of the client may be configured according to the payment environment configuration information.

As such, the payment environment of the client may be configured according to the client's country, and thus the user payment experience may be further improved.

Preferably, the configuration information may include at least one of the following: a merchandise pricing method and corresponding price information; and selectable payment methods, or selectable payment methods and the applicable conditions.

In this way, by providing the currency and the payment method corresponding to the country, it is convenient for the user to make a payment, and avoid unnecessary expenses. As such the user experience may be further enhanced.

Preferably, in the configuration information database, a prioritized payment method is set for at least one country. The configuration information further includes a prioritized payment method; an instruction for displaying the prioritized payment method; and an instruction for directly jumping to the prioritized payment method when the applicable conditions of the prioritized payment method are satisfied.

As such, in countries where a highly popular and convenient payment method exists, a direct jump/payment option list is provided to optimize the user's payment experience, and thus further promote the profit growth of the service providers.

According to another aspect of the present invention, a client configuration system including a server and a client is provided. In the client configuration system, an initialization of the client is performed, and the country information of the client is identified based on the device information; a configuration information request is sent to the server, the configuration information request including the country information; the server acquires the configuration information corresponding to the country information from a configuration information database, and sends the acquired configuration information to the client; and the client performs configuration according to the configuration information to complete the initialization of the client configuration information.

According to another aspect of the present invention, a server is provided. The server may include a processor, a transceiver, and a configuration information database. In the server, the configuration information database stores the information of countries and the corresponding configuration information in a correlative manner. The processor receives a configuration information request for client initialization through the transceiver and acquires the country information of the client from the configuration information request; acquires the configuration information corresponding to the country information from the configuration information database; and sends the acquired configuration information to the client through the transceiver to complete the initialization of the client configuration information.

According to another aspect of the present invention, a client is provided. The client may include a processor and a transceiver. During the initialization of the client, the processor of the client identifies the country information of the client based on the device information; sends a configuration information request to a server through the transceiver, the configuration information request including the country information; receives the configuration information that corresponds to the country information returned from the server; and completing the initialization of the client configuration information by configuring the client according to the configuration information.

As such, system and hardware supports are provided for the client configuration method.

### BRIEF DESCRIPTION OF THE DRAWINGS

The above and other objects, features, and advantages of the present invention will become more apparent through detailed illustration of exemplary embodiments of the present invention with reference to the accompanying drawings. Wherever possible, the same reference numbers will be used throughout the drawings to refer to the same or like parts.

FIG. 1 illustrates a system 10 including a server 20 and clients 1 . . . N.

FIG. 2 illustrates a schematic flowchart of a method for providing configuration information for a client consistent with an embodiment of the present invention.

FIG. 3 illustrates a schematic flowchart of a client configuration method consistent with an embodiment of the present invention.

FIG. 4 illustrates a schematic block diagram of a server 40 consistent with an embodiment of the present invention.

FIG. 5 illustrates a schematic block diagram of a client 50 consistent with an embodiment of the present invention.

FIG. 6 illustrates a detailed flow of a specific method for configuring a payment environment of a client according to a country consistent with an embodiment of the present invention.

### DETAILED DESCRIPTION

Detailed illustration of exemplary embodiments of the present invention will now be made with reference to the accompanying drawings. Although the drawings illustrate some preferred embodiments of the present invention, it should be understood that the present invention may be implemented in various forms and should not be limited to the embodiments set forth herein. Instead, these embodiments are provided so that the present invention will be thorough and complete, and will fully convey the scope of the invention to those skilled in the art.

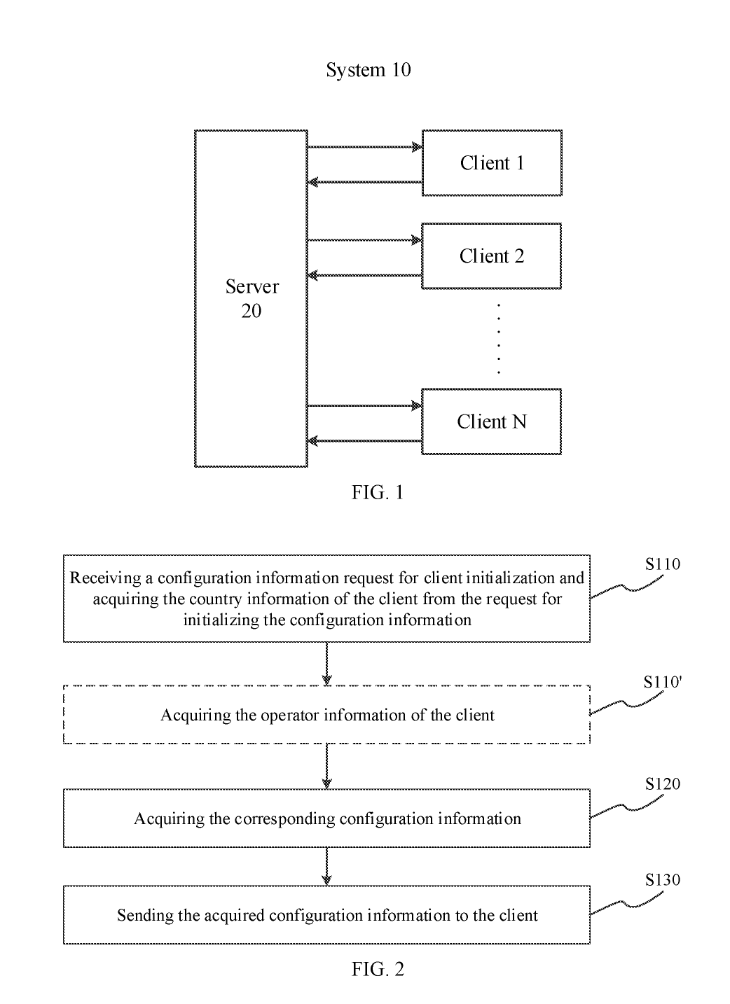

Online business is usually carried out between a server and a client. FIG. 1 illustrates a system 10 including a server 20 and clients 1 . . . N. The server 20 interacts with the client to, for example, facilitate the client to initialize and further conduct online business.

It is appreciated that although only one server 20 is illustrated in the figure, in practice, the system 10 may include a plurality of servers 20, and according to, for example, the region, etc., each server 20 may provide services for different client groupings that have dynamically variable compositions.

In the system 10 illustrated above, a configuration method corresponding to the principle of the present invention may be executed. FIG. 2 illustrates a schematic flowchart of a method for providing configuration information for a client consistent with an embodiment of the present invention. For example, in one embodiment, the server 20 in FIG. 1 may provide configuration information when one or more of the clients 1 . . . N are initialized.

In step S110, a configuration information request for client initialization may be received, and the country information may be acquired from the configuration information request.

In step S120, the configuration information corresponding to the country information may be acquired from the configuration information database of the server. The configuration information database may store the information of countries and the corresponding configuration information in a correlative manner.

In step S130, the acquired configuration information may be send to the client to complete the initialization of the client configuration information.

In one embodiment, the server may use the configuration information database to store the configuration information for each country, and may also provide the client with the configuration information corresponding to the client's country during the initialization stage of the client. As such, unnecessary configuration of the client, unnecessary consumption of the storage space, and unnecessary client updates may be avoided. Therefore, the smoothness for use may be improved, and thus the user experience may be improved.

In a preferred embodiment, the country information and the corresponding configuration information stored in the configuration information database may be updated when the server is connected to a new country and/or when the correlative configuration information changes. In other words, because the country information in the configuration information database can always be updated timely, the client may not need to pay attention to changes in the country information, instead, the client may only need to initialize the current configuration information of the corresponding country at startup. Therefore, the system compatibility and the system efficiency may be improved.

In a preferred embodiment, the configuration information may be payment environment configuration information. Therefore, according to a unified checkout counter for international payment of the present invention may provide different payment options according to different countries and different consumption levels to improve the user payment experience.

In a preferred embodiment, the configuration information may include a merchandise pricing method and the corresponding price information, and may optionally include payment methods, or selectable payment methods and the applicable conditions. In a preferred embodiment, the selectable payment methods may include one or more of the following: client mobile operator payment, credit card payment, saving card payment, and payment through a payment platform of the corresponding country.

The configuration information may include, for example, pricing items in RMB, U.S. dollar, or ruble to display the corresponding price information. The configuration information may also include selectable payment methods and the applicable conditions. For example, the credit card payment can only be selected for a bill of 100 yuan or over.

In one embodiment, the method shown in FIG. 2 may also include an optional step S110′.

In step S110′, the operator information of the client may be obtained from the configuration information request.

Through the acquisition of the operator information, it may greatly facilitate the majority of smartphone client users to make a payment. Of course, it is understandable that this step is not necessary (hence, shown as dashed lines in the figure). Although step S110′ is shown after step S110, it may be performed before or at the same time as step S110.

In one embodiment, a prioritized payment method may be set for at least one country in the configuration information database. The configuration information may also include a prioritized payment method; an instruction for displaying the prioritized payment method; and an instruction for directly jumping to the prioritized payment method when the applicable conditions of the prioritized payment method are satisfied.

For example, it is preferable to use Alipay to may payment in China, and to use operator payment for small transactions in India. The preferred payment may be taken directly, or may be displayed in a list, for example, to the user.

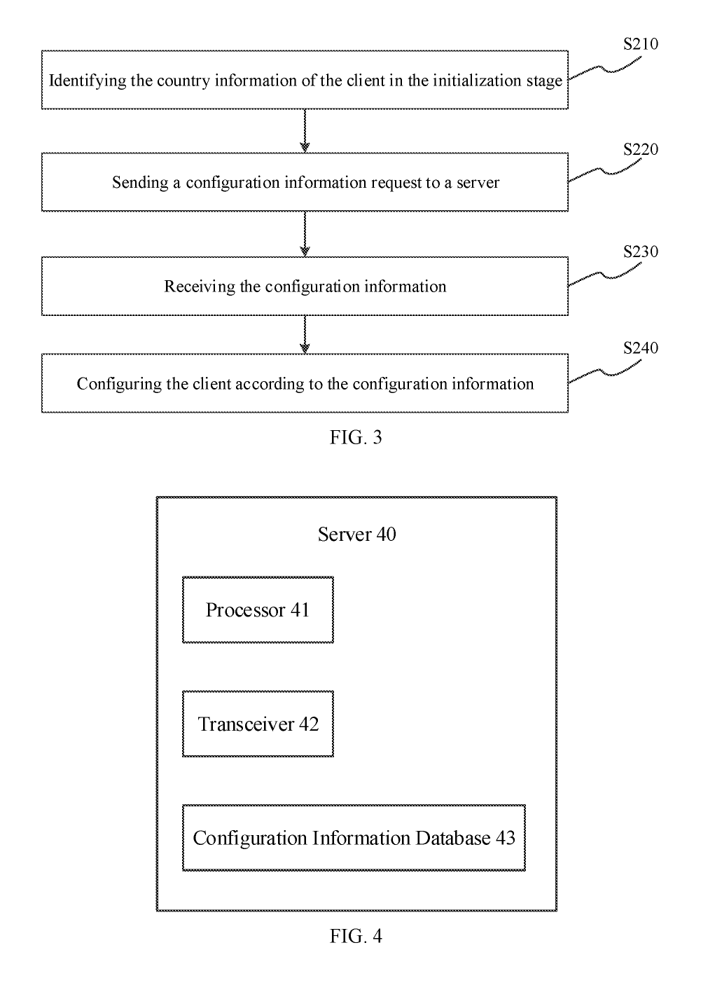

The actions performed by the server for the configuration of the client are described above, and the configuration method on the client side will now be illustrated with reference to FIG. 3.

FIG. 3 illustrates a schematic flowchart of a client configuration method consistent with an embodiment of the present invention.

In step S210, an initialization of the client may be performed, and the country information of the client may be identified based on the device information of the client.

In step S220, a configuration information request may be sent to a server, the configuration information request including the country information.

In step S230, the configuration information returned from the server that corresponds to the country information may be received.

In step S240, the initialization of the client configuration information may be completed by configuring the client according to the configuration information.

The client may acquire the corresponding configuration information by sending the country information to the server during the initialization stage, and may set up itself to improve the configuration efficiency and save the storage space. In the meantime, irrelevant updates due to adding a new country may be avoided. Similar to the above description on the server with reference to FIG. 2, in some embodiments, the configuration method illustrated in FIG. 3 may be directed to define a payment environment, a pricing method, a price information, and a payment method (for example, a prioritized payment method). The detailed description will not be repeated herein.

The methods taken by the server side and the client side for client configuration are detailed above with reference to FIGS. 2 and 3. In one embodiment, the system 20 in FIG. 1 may include a server and a client that execute the methods illustrated in FIG. 2 and FIG. 3, respectively. Therefore, a client configuration system including the server and the client described above may be obtained. In the client configuration system, an initialization of the client may be performed, and the country information of the client may be identified based on the device information; a configuration information request may be sent to the server, the configuration information request including the country information; the server may acquire the configuration information corresponding to the country information from a configuration information database, and send the acquired configuration information to the client; and the client may perform configuration according to the configuration information to complete the initialization of the client configuration information.

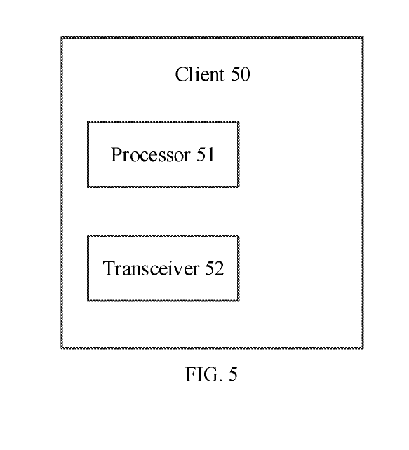

Further, the respective hardware configurations of the server and the client executing the above methods will be described with reference to FIG. 4 and FIG. 5, respectively. Because many of the functions of these hardware are the same as the functions of the corresponding steps described above with reference to FIG. 2 and FIG. 3, some of the details will not be described again, and reference should be made to the corresponding description above.

FIG. 4 illustrates a schematic block diagram of a server 40 consistent with an embodiment of the present invention.

As shown in FIG. 4, the server 40 may include a processor 41, a transceiver 42, and a configuration information database 43. The configuration information database 43 may store the information of countries and the corresponding configuration information in a correlative manner. The processor 41 may receive a configuration information request for client initialization through the transceiver 42 and acquire the country information of the client from the configuration information request; may acquire the configuration information corresponding to the country information from the configuration information database 43, and may send the acquired configuration information to the client through the transceiver 42 to complete the initialization of the client configuration information.

FIG. 5 illustrates a schematic block diagram of a client 50 consistent with an embodiment of the present invention.

As shown in FIG. 5, the client 50 may include a processor 51 and a transceiver 52. During the initialization of the client 50, the processor 51 may identify the country information of the client 50 based on the device information, and may send a configuration information request to a server through the transceiver 52. The configuration information request may include the country information. The transceiver 52 may receive the configuration information that corresponds to the country information returned from the server, and may configure the client 50 according to the configuration information to complete the initialization of the client configuration information.

The server 40 in FIG. 4 may serve as the server 20 in FIG. 1, and the client 50 in FIG. 5 may serve as any client 1 . . . N in FIG. 1, and thus implementation of the disclosed methods and system of the present invention can be achieved.

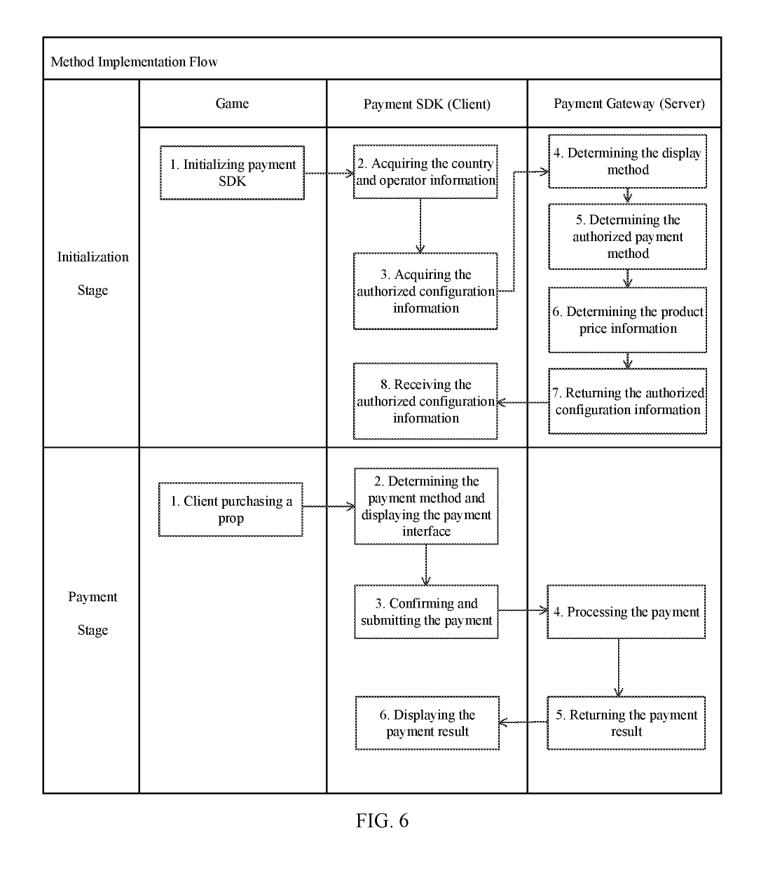

In the following, specific examples according to the above methods, systems, servers, and clients of the present invention will be provided with reference to Tables 1-4 and FIG. 6.

In one embodiment, the server (which may be, for example, the server 20 in FIG. 1, or the server 40 in FIG. 4) may be able to provide the client with configuration information for different countries, such as payment environment configuration information.

Table 1 illustrates merchandise pricing methods and price information classified by country that are stored in the configuration information database by the server. As shown in Table 1, a unique identifier may be assigned to each of the props A, B, and C in a game on the server side. In the meantime, various information such as the price of each prop, the currency, the name to be displayed to the users, etc. may be configured according to the charging points supported by the countries which the server has been connected to (for example, India and China have been connected).

TABLE 1
Merchandise pricing methods and price information classified by country

| | Unique | | | | |
|---|---|---|---|---|---|
| Prop | Identifier | Country | Amount | Currency | Name Displayed |
| A | 000001 | India (IN) | 20 | Rupee (INR) | 100 coins |
| | | China (CN) | 5 | RMB (CNY) | 100 gold coins |
| | | Other Countries (XX) | 1 | U.S. Dollar (USD) | 100 coins |
| B | 000002 | India (IN) | 40 | Rupee (INR) | 200 coins |
| | | China (CN) | 10 | RMB (CNY) | 200 gold coins |
| | | Other Countries (XX) | 2 | U.S. Dollar (USD) | 200 coins |
| C | 000003 | India (IN) | 100 | Rupee (INR) | 1000 coins |
| | | China (CN) | 50 | RMB (CNY) | 1000 gold coins |
| | | Other Countries (XX) | 10 | U.S. Dollar (USD) | 1000 coins |

In this way, when online business (for example, the game in the present example) are expanded to a new country, that is, when the server is connected to a new country, e.g. Russia, it only needs to add the charging points corresponding to Russia in the backstage (referring to Table 2). Additionally, the number of the charging points (i.e., the types of props that can be purchased) in each country may be different. For example, in the present example, Russia has only two charging points, i.e. 1 Ruble and 2 Rubles, and thus only the two need to be configured.

TABLE 2
Merchandise pricing methods and price information after adding a new country

| | Unique | | | | |
|---|---|---|---|---|---|
| Prop | Identifier | Country | Amount | Currency | Name Displayed |
| A | 000001 | India (IN) | 20 | Rupee (INR) | 100 coins |
| | | China (CN) | 5 | RMB (CNY) | 100 gold coins |
| | | Russia | 1 | Ruble (RUB) | 100 coins |
| | | Other Countries (XX) | 1 | U.S. Dollar (USD) | 100 coins |
| B | 000002 | India (IN) | 40 | Rupee (INR) | 200 coins |
| | | China (CN) | 10 | RMB (CNY) | 200 gold coins |
| | | Russia | 2 | Ruble (RUB) | 200 coins |
| | | Other Countries (XX) | 2 | U.S. Dollar (USD) | 200 coins |
| C | 000003 | India (IN) | 100 | Rupee (INR) | 1000 coins |
| | | China (CN) | 50 | RMB (CNY) | 1000 gold coins |
| | | Other Countries (XX) | 10 | U.S. Dollar (USD) | 1000 coins |

As such, according to different countries, the props in the game may be flexibly displayed with different names, prices, currencies, and other information. In addition, to be able to use globally accepted payment methods (such as VISA or MasterCard) in other countries, an “other country” entry may be configured for each merchandise, such that as long as the payment server is capable of making payments with, for example, VISA or MasterCard, the game can be extended to all countries in the world.

The client and the server may communicate with each other using the unique identifier of the merchandise without the need to consider the complex information as that shown in Tables 1 and 2. Adding the new country configuration information for Russia on the server may not have any impact on the clients in other countries (for example, China, India) that have already been configured. For clients in Russia, the configuration information corresponding to Russia may be used to replace the configuration information of other countries. In one embodiment, when the server adds the new country configuration information for Russia, the configuration information database may be updated in a correlative manner. As such, when a client in Russia starts up, the client may be able to directly obtain the updated configuration information associated with Russia. As a result, the compatibility may be improved in a client-side transparent manner.

In one embodiment, this means that there is no need to update the APP on the mobile clients each time a new country is added.

Table 3 illustrates merchandise pricing methods and price information classified by country that are stored in the configuration information database by the server.

TABLE 3
Payment method information by country

| | Display | | |
|---|---|---|---|
| Country | Method | Payment Method | List of Supported Amount |
| India | Operator | Operator Payment | 20INR, 40INR, 100INR . . . |
| | Preferred | PAYTM | Any Amount |
| | | Credit Card | Any Amount |
| China | List Selections | Operator Payment | 1CNY, 5CNY, 10CNY . . . |
| | | Alipay | Any Amount |
| | | Saving Card | Any Amount |
| | | Credit Card | Any Amount |
| Russia | List Selections | Operator Payment | 1RUB, 2RUB . . . |
| | | VISA | Any Amount |
| Other | List Selections | VISA | Any Amount |

Because different countries may support different payment methods, and the charging points supported by the operators in different countries may also be different, each time when a country is added, the payment methods supported by the present country may be configured according to the method described above. Since for each country, different payment methods may have different popularity and convenience levels, the prioritized payment methods may be configured based on the actual situation in each country.

For example, payments may more likely be successfully paid through operators, and thus may be configured as an “operator preferred” method. When the amount matches the amount supported by the operator (typically a small amount, such as purchasing a prop A with a price of 20 INR), deduction may be directly made through the operator payment method without the user making any choice. When the amount does not match (typically a large amount), a list may be provided to the user for making a selection. In other countries, operator payment may not be so popular, and thus a list may be provided to the user to choose the payment method.

After the server configured the price and the payment information, for example, as that shown in Tables 1-3, the client may only need to identify the country that the client is currently in according to the device environment information during initialization to dynamically acquire the displayable merchandise information and payment method information of the current county. Table 4 illustrates the query interface that the server provides to the client to display merchandise information and payment method information. That is, server may provide configuration information to the clients by country (in the present example, China, India, Russia, and other countries).

TABLE 4
Price and payment information by country

| Country | Merchandise Information | | Payment Method |
|---|---|---|---|
| Clients in | 100 gold coins | 5 CNY | Operator, Alipay, Saving |
| | | | Card, Credit Card |
| China | 200 gold coins | 10 CNY | Operator, Alipay, Saving |
| | | | Card, Credit Card |
| | 1000 gold coins | 50 CNY | Alipay, Saving Card, Credit |
| | | | Card |
| Clients in | 100 coins | 20 INR | Operator, PAYTM, Credit |
| | | | Card |
| India | 200 coins | 40 INR | Operator, PAYTM, Credit |
| | | | Card |
| | 1000 coins | 100 INR | Operator, PAYTM, Credit |
| | | | Card |
| Clients in | 100 coins | 1 RUB | Operator, VISA |
| Russia | 200 coins | 2 RUB | Operator, VISA |
| Clients in | 100 coins | 1 USD | VISA |
| Other | 200 coins | 2 USD | VISA |
| Countries | 1000 coins | 10 USD | VISA |

Therefore, based on the amount of the merchandise selected by the user, the client may dynamically display the payment method according to the display method acquired from the server. For example, a user selects prop A in India, and the price is 20 INR. Because “operator preferred” is the display method in India and 20 INR is an amount supported by the operator, the client may thus skip the user's choice and directly make deduction using the operator payment method. However, for the same prop A, when the user makes the selection is in China, and the price is 5 RMB, according to the above configuration, a payment method selection list including operator, Alipay, saving card, and credit card may be displayed to allow the user make a choice, and then complete the subsequent payment process.

A detailed flow of a specific method for configuring the payment environment of the client according to the country in an embodiment is provided with reference to FIG. 6.

### 1. Initialization Stage

When a game is started on a client, an initialization method of the payment software development kit (SDK) may be called to execute the related initialization;

The international mobile subscriber identity (IMSI) of the mobile subscriber identification module (SIM) card may be read out. The prefix of the IMSI may include the mobile country code (MCC) and the mobile network code (MNC). Based on the MCC information, the country of the client may be determined, and based on MCC and MNC, the operator information corresponding to the mobile card may be determined;

The authorized configuration information may be acquired from a payment gateway (e.g., a server in FIG. 1 or FIG. 4);

The payment gateway may acquire the display method information of the game in the designated country according to the game and the country information in the request information;

The payment gateway may acquire the information of the authorized payment method of the game in the designated country according to the game, the country, and the operator information in the request information, including the payment method identifier (ID), the payment method name, the list of supported amount, and the displayed order of the payment method;

The payment gateway may acquire the merchandise price information of the game in the designated country according to the game and the country information in the request information, including the merchandise ID, the merchandise displayed name, the merchandise price, and the currency;

The authorized configuration information may then be returned to the payment SDK;

The authorized configuration information may be received and stored.

### 2. Payment Stage

The payment SDK may display the payment interface according to the display method in the authorized configuration information;

When the display method is an “operator preferred” method, whether the game has an authorized operator payment method may be determined. When an operator payment method is activated, whether the price of the prop matches the list of the supported amount may be determined. When the price of the prop matches the list of the supported amount, the operator payment method may be selected to make the payment. When the price of the prop does not match the list of the supported amount, based on the display order of the payment methods, each payment method may be sequentially determined whether the price of the prop matches and a payment method may finally be determined;

When the display method is an “list selection” method, based on the payment method configuration information, a payment method selection interface may be displayed according to the payment method display order, and the user may select a specific payment method;

The user may confirm the payment, and the payment SDK may submit a payment order request to the payment gateway;

The payment gateway may process the order upon the request;

The payment gateway may return a payment processing result to the payment SDK;

The payment SDK may display a corresponding result page based on the returned result.

The above discloses an example of how to configure a client in a game payment environment. It should be understood by those skilled in the art that the disclosure in combination with Tables 1-4 and FIG. 6 above is only for advancing the understanding of the examples provided according to the principle of the present invention, rather than specifically limiting the applications of the present invention.

In addition, the method according to the present invention may also be implemented as a computer program product. The computer program product may include a computer-readable medium, in which a computer program used to execute the above functions defined in the method of the present invention may be stored. Those skilled in the art should also understand that combinations of various exemplary logical blocks, modules, circuits, and algorithm steps illustrated in the present invention may be implemented as electronic hardware, computer software, or a combination of the two.

The flowcharts and block diagrams in the figures illustrate the architecture, the functionality, and the operation that may be possibly implemented according to the systems and the methods of various embodiments of the present invention. In this regard, each block of the flowcharts or block diagrams may represent a module, a program section, or a portion of a code. The module, the program section, or the portion of the code may include one or more executable instructions that are used to implement the specified logical functions. It should also be noted that in some alternative implementations, the functions labeled in the blocks may be implemented in an order different from the order indicated in the drawings. For example, two consecutive blocks may in fact be executed substantially in parallel, and sometimes may even be executed in the reverse order depending on the functions involved. It is also to be noted that each block of the block diagrams and/or flowcharts, and combinations of blocks of the block diagrams and/or flowcharts may be implemented by special purpose hardware-based systems that are used to execute specified functions or operations, or may be implemented using a combination of dedicated hardware and computer instructions.

The various embodiments of the present invention have been described above. The above description is exemplary, not exhaustive, and thus is not limited to the disclosed embodiments. Many modifications and variations should be apparent to those skilled in the art without departing from the scope and spirit of the illustrated embodiments. The terminology used herein was chosen to best explain the principles of the embodiments, the practical applications, or the technical improvements to technologies in the market place or to enable others of ordinary skill in the art to understand the embodiments disclosed herein.

1. A method for providing configuration information to a client, comprising:
receiving a configuration information request for client initialization and acquiring country information of the client from the request for initializing the configuration information;
acquiring configuration information corresponding to the country information from a configuration information database of a server, wherein the configuration information database stores information of countries and corresponding configuration information in a correlative manner; and
sending the acquired configuration information to the client to complete initialization of the configuration information of the client.

2. The method according to claim 1, wherein the information of countries and the corresponding configuration information stored in the configuration information database are updated when the server is connected to a new country or when the correlative configuration information changes.

3. The method according to claim 1, wherein the configuration information is payment environment configuration information.

4. The method according to claim 3, wherein the configuration information includes at least one of:
a merchandise pricing method and corresponding price information; and
selectable payment methods, or selectable payment methods and applicable conditions thereof.

5. The method according to claim 4, wherein the selectable payment methods include at least one of:
payment by a mobile client operator;
payment by a credit card;
payment by a saving card; and
payment through a payment platform of a corresponding country.

6. The method according to claim 5, further including:
acquiring operator information of the client from the configuration information request.

7. The method according to claim 4, wherein in the configuration information database, a prioritized payment method is set for at least one country, and the configuration information also includes:
the prioritized payment method;
an instruction for displaying the prioritized payment method; and
an instruction for directly jumping to the prioritized payment method when applicable conditions of the prioritized payment method are satisfied.

8. A configuration method of a client, comprising:
performing an initialization of the client, and identifying country information of the client based on device information;
sending a configuration information request to a server, wherein the configuration information request includes the country information;
receiving configuration information that corresponds to the country information returned from the server; and
completing initialization of client configuration information by configuring the client according to the configuration information.

9. The method according to claim 8, wherein:
the configuration information is payment environment configuration information; and
when configuring the client according to the configuration information, a payment environment of the client is configured according to the payment environment configuration information.

10. The method according to claim 8, wherein the configuration information includes at least one of:
a merchandise pricing method and corresponding price information; and
selectable payment methods, or selectable payment methods and applicable conditions thereof.

11. The method according to claim 9, wherein in a configuration information database of the server, a prioritized payment method is set for at least one country, and the configuration information also includes:
the prioritized payment method;
an instruction for displaying the prioritized payment method; and
an instruction for directly jumping to the prioritized payment method when applicable conditions of the prioritized payment method are satisfied.

12. A client configuration system, comprising a server and a client, wherein:
the client performs initialization, identifies country information of the client based on device information of the client, and sends a configuration information request to the server, wherein the configuration information request includes the country information;
the server acquires configuration information corresponding to the country information from a configuration information database of the server, and sends the acquired configuration information to the client, wherein the configuration information database stores information of countries and corresponding configuration information in a correlative manner; and
the client performs configuration according to the configuration information to complete initialization of client configuration information.

13. The client configuration system according to claim 12, wherein:
the server comprises a processor, a transceiver, and a configuration information database, wherein:
the processor receives the configuration information request for client initialization through the transceiver; acquires the country information of the client from the configuration information request; acquires configuration information corresponding to the country information from the configuration information database; and sends the acquired configuration information to the client through the transceiver to complete the initialization of client configuration information.

14. The client configuration system according to claim 12, wherein the information of countries and the corresponding configuration information stored in the configuration information database are updated when the server is connected to a new country or when correlative configuration information changes.

15. The client configuration system according to claim 12, wherein:
the client comprises a processor and a transceiver, wherein:
the processor of the client identifies the country information of the client based on the device information of the client during the initialization of the client; sends a configuration information request to the server through the transceiver; receives the configuration information returned from the server that corresponds to the country information; and completing the initialization of client configuration information by configuring the client according to the configuration information.

16. The method according to claim 8, wherein:
a configuration information database of the server stores information of countries and corresponding configuration information in a correlative manner.

17. The method according to claim 8, wherein:
the country information of the client is acquired from an international mobile subscriber identity (IMSI) of a mobile subscriber identification module (SIM) card of the client.

18. The method according to claim 8, wherein:
the configuration information request further includes operator information of the client, and
the operator information of the client is acquired from an IMSI of a mobile SIM card of the client.
